(19) United States
(12) Patent Application Publication
(10) Pub. No.: US 2015/0084702 A1
(43) Pub. Date: Mar. 26, 2015

(54) ELECTROSTATIC DISCHARGE (ESD) CIRCUITRY

(71) Applicant: TriQuint Semiconductor, Inc., Hillsboro, OR (US)

(72) Inventor: Bruce J. Tesch, Melbourne, FL (US)

(73) Assignee: TriQuint Semiconductor, Inc., Hillsboro, OR (US)

(21) Appl. No.: 14/038,127

(22) Filed: Sep. 26, 2013

(51) Int. Cl. H02H 9/04

(52) U.S. Cl. CPC H02H 9/04
USPC 330/298; 361/56; 29/825

(57) ABSTRACT

Embodiments of the present disclosure describe electrostatic discharge (ESD) circuitry and associated techniques and configurations. In one embodiment, ESD circuitry includes a first node coupled with a supply voltage node and a ground node, a first transistor coupled with the first node and the supply voltage node, a second transistor coupled with the first node and the ground node, a second node coupled with the first transistor and the second transistor, a third transistor coupled with the second node and a third node coupled with the third transistor, wherein a first time period to charge the first node is less than a second time period to discharge the third node. Other embodiments may be described and/or claimed.

### FIELD

Embodiments of the present disclosure generally relate to the field of integrated circuits, and more particularly, to electrostatic discharge (ESD) circuitry and associated techniques.

### BACKGROUND

Present electrostatic discharge (ESD) circuitry may experience a high in-rush current when a power supply has a fast rise time and, in some cases, may experience oscillation from gain feedback during normal operation of a chip. Techniques and configurations to provide stable ESD protection with reduced in-rush current for a fast-rising supply may be desirable.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a die including electrostatic discharge (ESD) circuitry, according to various embodiments.

FIG. 2 schematically illustrates ESD circuitry, according to various embodiments.

FIG. 3 schematically illustrates an alternative configuration of ESD circuitry, according to various embodiments.

FIG. 4 schematically illustrates an alternative configuration of ESD circuitry, according to various embodiments.

FIG. 5 schematically illustrates an alternative configuration of ESD circuitry, according to various embodiments.

FIG. 6 schematically illustrates an alternative configuration of ESD circuitry, according to various embodiments.

FIG. 7 schematically illustrates an alternative configuration of ESD circuitry, according to various embodiments.

FIG. 8a schematically illustrates an alternative configuration of ESD circuitry, according to various embodiments.

FIG. 8b schematically illustrates an alternative configuration of ESD circuitry, according to various embodiments.

FIG. 9 schematically illustrates an example graph of current of a supply voltage node over time for the ESD circuitry of FIG. 2, according to various embodiments.

FIG. 10 schematically illustrates an example graph of voltage of various nodes over time for the ESD circuitry of FIG. 2, according to various embodiments.

FIG. 11 is a flow diagram of a method for fabricating or designing ESD circuitry, according to various embodiments.

FIG. 12 schematically illustrates an example system including a die having ESD circuitry, according to various embodiments.

### DETAILED DESCRIPTION

Embodiments of the present disclosure describe electrostatic discharge (ESD) circuitry and associated techniques and configurations. In the following detailed description, reference is made to the accompanying drawings which form a part hereof, wherein like numerals designate like parts throughout, and in which is shown by way of illustration embodiments in which the subject matter of the present disclosure may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous. The term “coupled” may refer to a direct connection, an indirect connection, or an indirect communication.

The term “coupled with,” along with its derivatives, may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other.

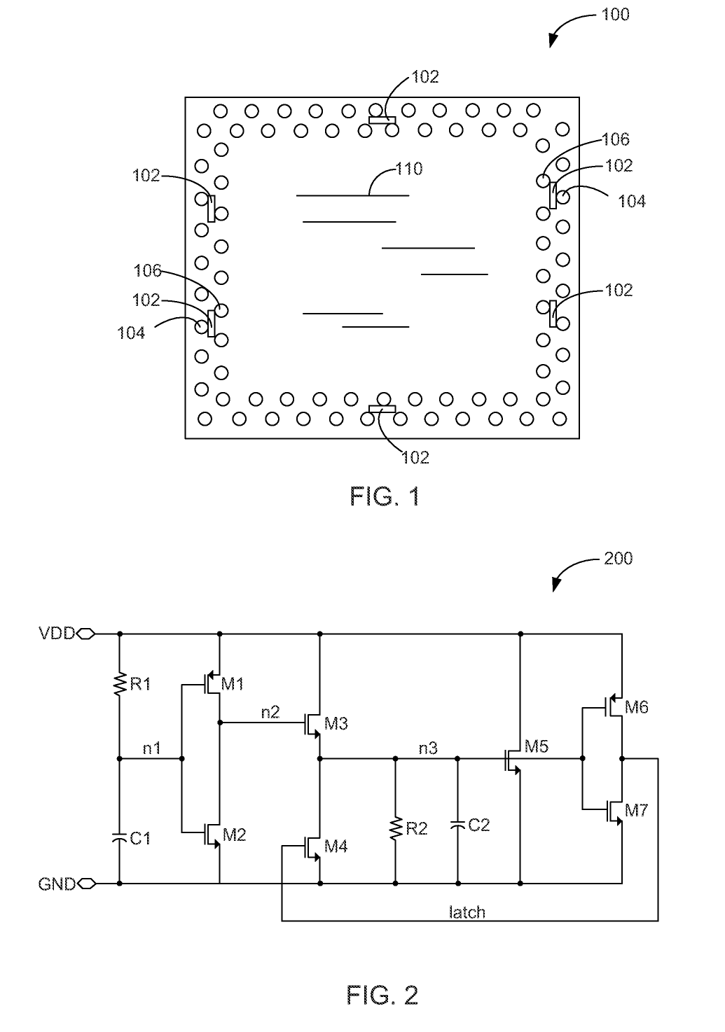

FIG. 1 schematically illustrates a die 100 including electrostatic discharge (ESD) circuitry, according to various embodiments. In some embodiments, the die 100 may include ESD circuitry in the form of one or more transient ESD clamps (hereinafter “ESD clamps 102”). The ESD clamps 102 may be configured to protect other circuitry 110 on the die from ESD events such as, for example, static shock or other power surge. The other circuitry 110 may include, for example, one or more transistors, memory cells, or other active devices and/or interconnect circuitry to route electrical signals to or from the active devices, or any other circuitry that may be sensitive to an ESD event.

In some embodiments, the ESD clamps 102 may be formed on an active side of the die 100 using semiconductor fabrication techniques such as, for example, complementary metal-oxide-semiconductor (CMOS) technology or other suitable technology. The ESD clamps 102 may be disposed adjacent to or between power connections 104 and ground connections 106 of the die 100. For example, in some embodiments, one or more of the power connections may be coupled with the supply voltage (VDD or VSS) node in the ESD circuitry 200 of FIGS. 2-8 and one or more of the ground connections 106 may be coupled with the ground (GND) node in the ESD circuitry 200 of FIGS. 2-8.

The power connections 104 and ground connections 106 may include, for example, interconnect structures or contacts such as, for example, bumps, pillars, traces, vias, pads or other suitable structures and may be configured to respectively provide a supply voltage and ground for operation of the die (e.g., processing, sending/receiving input/output signals, storing information, executing code, etc.). As used herein, “ground” may represent any suitable voltage including non-zero voltage.

In the depicted embodiment, the power connections 104, ground connections 106 and ESD clamps 102 are disposed in a peripheral region of the die 100 and the other circuitry 110 is disposed in a central region of the die 100. In other embodiments, the power connections 104, ground connections 106, ESD clamps 102 and/or other circuitry 110 may be arranged in other suitable configurations than depicted.

FIG. 2 schematically illustrates ESD circuitry 200, according to various embodiments. The ESD circuitry 200 may, for example, represent an ESD clamp of the ESD clamps 102 depicted in FIG. 1. In some embodiments, the ESD circuitry 200 includes a positive supply voltage node (hereinafter “VDD”) and a ground node (hereinafter “GND”). In some embodiments, the VDD may be coupled with one or more of the power connections 104 and the GND may be coupled with one or more of the ground connections 106 described in connection with FIG. 1.

According to various embodiments, the ESD circuitry 200 may include a first node, n1, coupled with VDD and GND, a first transistor, M1, coupled with the first node n1 and VDD, a second transistor, M2, coupled with the first node n1 and GND, a second node, n2, coupled with the first transistor M1 and the second transistor M2, a third transistor, M3, coupled with the second node n2 and a third node, n3, coupled with the third transistor M3. In some embodiments, the ESD circuitry 200 may further include a fourth transistor, M4, coupled with the third node n3, a fifth transistor, M5, coupled with the third node n3, a sixth transistor M6 coupled with the third node n3, a seventh transistor M7 coupled with the third node n3 and a latch node configured to couple the fourth transistor M4 with the third node n3, as can be seen.

In some embodiments, the first node n1 may be coupled with an inverter including the first transistor, M1, and the second transistor, M2, as can be seen. The first node n1 may be coupled with a gate of the first transistor M1 and the second transistor M2, a source of the first transistor M1 may be coupled with VDD, a source of the second transistor M2 may be coupled with GND, and a drain of the first transistor M1 may be coupled with a drain of the second transistor M2, as can be seen. The second node n2 may be coupled with a drain of the first transistor M1 and a drain of the second transistor M2.

In some embodiments, the third transistor M3 may serve as a source follower. The second node n2 may be coupled with a gate of the third transistor M3. A drain of the third transistor M3 may be coupled with VDD. The third node n3 may be coupled with a source of the third transistor M3 and a drain of the fourth transistor M4. A source of the fourth transistor M4 may be coupled with GND. In some embodiments, the third node n3 may be coupled with a gate of the fifth transistor M5, a gate of the sixth transistor M6 and a gate of the seventh transistor M7. The latch node may be coupled with a drain of the sixth transistor, a drain of the seventh transistor and a gate of the fourth transistor.

According to various embodiments, one or more resistors and/or capacitors may be coupled to one or more of the first node n1 and the third node n3. A resistance or capacitance of the nodes n1 and/or n3 may be based, at least in part, on the one or more resistors or capacitors. For example, a resistance of the first node n1 may be determined based on one or more resistors (hereinafter “R1”) coupled with the first node n1 and a capacitance of the first node n1 may be determined based on one or more capacitors (hereinafter “C1”) coupled with the first node n1. Resistance and capacitance of the third node n3 may be determined based on one or more resistors (hereinafter “R2”) and one or more capacitors (hereinafter “C2”) coupled with the third node n3. In some embodiments, capacitance of the third node n3 may be primarily based on a gate capacitance of the fifth transistor M5 and capacitors such as C2 may not be needed in the ESD circuitry 200.

According to various embodiments, R1 and C1 may be tuned or configured to provide a first time period (e.g., constant, τ1) to charge the first node n1. R2 and C2 may be tuned configured to provide a second time period (e.g., constant, T2) to discharge the third node n3. In some embodiments, the first time period (e.g., τ1) may be less than the second time period (e.g., τ2) to provide ESD circuitry 200 of a transient ESD clamp having improved stability and reduced in-rush current relative to other transient ESD clamps. For example, a shorter first time period (e.g., τ1) may limit in-rush current to the ESD circuitry 200 and a longer second time period (e.g., τ2) may allow complete discharge of an external ESD capacitance (e.g., 100 picoFarads for human body model) through the ESD circuitry 200. The ESD circuitry 200 may have the stability of a 1-inverter clamp and maintain ESD protection level while reducing in-rush current by a factor of about 10⁵ for a 1 microsecond (μs) rise time supply.

In some embodiments, the first time period may begin when VDD is turned on to provide a supply voltage and end when C1 has charged to a point where the second node n2 is low enough to turn off the third transistor M3. The second time period may begin when the third transistor M3 is set to an off-state and may end when the fourth transistor M4 is set to an on-state (normal power-up). The first time period and second time period may be configured using other suitable techniques in other embodiments.

In some embodiments, the second time period may be about an order of magnitude longer than the first time period. For example, in some embodiments, the second time period may be at least seven times greater than the first time period. In some embodiments, the first time period may have a value from 30 nanoseconds (ns) to 300 ns and the second time period may have a value from 300 ns to 3000 ns. In one embodiment, the first time period may be about 40 ns and the second time period may be about 800 ns. In another embodiment, the first time period may be 100 ns and the second time period may be about 1000 ns. In one embodiment, the first time period may be 180 ns and the second time period may be 1230 ns. In one embodiment, the first time period has a value less than 1 microsecond and the second time period is greater than the first time period. The first time period and the second time period may have a wide variety of other suitable values in other embodiments.

According to some embodiments, R1 and C1 may create a shorter first time period, which may only allow the voltage of the second node n2 to go high when VDD (e.g., 5 volt (V)) has a fast rise time (e.g., less than 1 μs). When the voltage of second node n2 goes high, the third transistor M3 may turn on and pull a voltage of the third node n3 up such that the fifth transistor M5 can sink the ESD current (e.g., ˜1.33 amperes (A) in some embodiments). The first time period may cause the voltage of the second node n2 to quickly go low, turning off the third transistor M3. The longer second time period created by R2 and C2 (and/or gate capacitance of fifth transistor M5) may discharge a voltage of the third node n3 at a slower rate. Using the first time period and second time period in this manner may limit in-rush current while allowing complete discharge of an external ESD capacitor (e.g., 100 picoFarads for human body model) through the ESD circuitry 200. A gate capacitance of the fifth transistor M5 may be greater than a gate capacitance of other transistors in the ESD circuitry 200 in order to advantageously tune the longer second time period to discharge the third node n3. Using the gate capacitance of the fifth transistor to primarily provide capacitance for tuning the second time period may save area on the die (e.g., die 100 of FIG. 1) for the ESD circuitry 200. The latch node may ensure that a gate of the fifth transistor M5 is quickly pulled to ground by the fourth transistor M4 during normal operation once the gate of the fifth transistor M5 has discharged to a threshold voltage of fifth transistor M5. In some embodiments, stability of the ESD circuitry 200 against oscillation may be improved because a single inverter may drive the third transistor T3. In some embodiments, the third transistor T3 may have a voltage gain that is less than 1.

In a first embodiment of the ESD circuitry 200, the first transistor M1 may have a width of 40 microns and a channel length of 0.6 microns, the second transistor M2 may have a width of 10 microns and a channel length of 0.6 microns, the third transistor M3 may have a width of 40 microns and a channel length of 0.6 microns, the fourth transistor M4 may have a width of 10 microns and a channel length of 0.6 microns, the fifth transistor M5 may have a width of 2000 microns and a channel length of 0.6 microns, the sixth transistor M6 may have a width of 2 microns and a channel length of 0.6 microns and the seventh transistor M7 may have a width of 10 microns and a channel length of 0.6 microns. In the first embodiment, R1 may have an effective resistance of 400,000 ohms and R2 may have an effective resistance of 200,000 ohms.

In other embodiments, the transistors (e.g., M1, M2, etc.) and/or resistors (e.g., R1, R2) may have other suitable values. The other suitable values may include different nominal values than described above, but may have a same relative value (e.g., greater or less than) when compared with other transistors or resistors of the ESD circuitry 200. For example, in some embodiments, the width of the first transistor may be greater than the width of the second transistor, which may increase a switching point of the inverter formed by transistors M1 and M2. The fifth transistor M5 may have a width that is substantially larger than the width of the other transistors in the ESD circuitry 200. The sixth transistor M6 may have a width that is less than a width of the seventh transistor M7, which may decrease a switching point of the inverter formed by transistors M6 and M7.

In a second embodiment of the ESD circuitry 200, the first transistor M1 may have a width of 40 microns and a channel length of 0.7 microns, the second transistor M2 may have a width of 10 microns and a channel length of 0.7 microns, the third transistor M3 may have a width of 20 microns and a channel length of 0.7 microns, the fourth transistor M4 may have a width of 10 microns and a channel length of 0.7 microns, the fifth transistor M5 may have a width of 2880 microns and a channel length of 0.7 microns, the sixth transistor M6 may have a width of 2 microns and a channel length of 0.7 microns and the seventh transistor M7 may have a width of 10 microns and a channel length of 0.6 microns. In the second embodiment, R1 may have an effective resistance of ˜400,000 ohms and R2 may have an effective resistance of ˜200,000 ohms. In other embodiments, the transistors (e.g., M1, M2, etc.) and/or resistors (e.g., R1, R2) may have other suitable values.

FIG. 3 schematically illustrates an alternative configuration of ESD circuitry 300, according to various embodiments. The ESD circuitry 300 may comport with embodiments described in connection with ESD circuitry 200 of FIG. 2, except that the one or more resistors R1 of FIG. 2 have been replaced by one or more additional transistors (hereinafter “eighth transistor M8”). According to various embodiments, a resistance of the first node n1 may be based on the eighth transistor M8.

The eighth transistor M8 may include a source coupled with VDD, a drain coupled with the first node n1 and a gate coupled with GND, as can be seen. In some embodiments, the eighth transistor M8 may be a P-type field effect transistor (PFET). Replacing R1 of the ESD circuitry 200 with the eighth transistor M8 may reduce die area in the ESD circuitry 300 relative to the ESD circuitry 200.

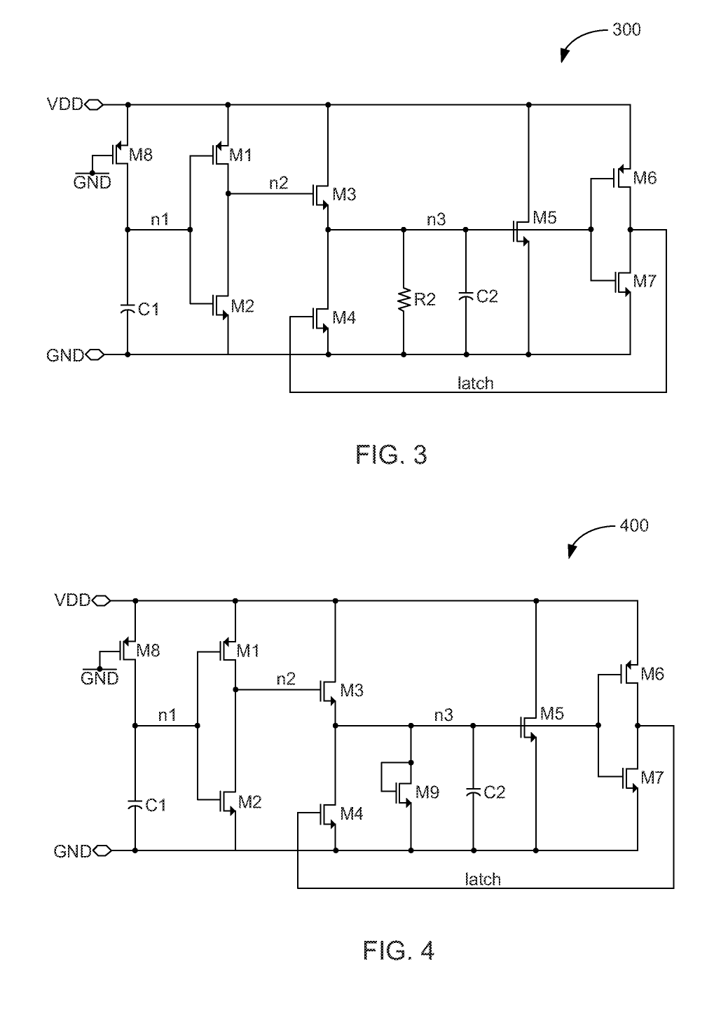

FIG. 4 schematically illustrates an alternative configuration of ESD circuitry 400, according to various embodiments. The ESD circuitry 400 may comport with embodiments described in connection with ESD circuitry 300 of FIG. 3, except that the one or more resistors R2 of FIG. 3 have been replaced by one or more additional transistors (hereinafter “ninth transistor M9”). According to various embodiments, a resistance of the third node n3 may be based on the ninth transistor M9.

The ninth transistor M9 may include a source coupled with GND, a drain coupled with the third node n3 and a gate coupled with the third node n3, as can be seen. In some embodiments, the ninth transistor M9 may be a zero threshold voltage transistor. Replacing R2 of the ESD circuitry 300 with the ninth transistor M9 may reduce die area in the ESD circuitry 400 relative to the ESD circuitry 300.

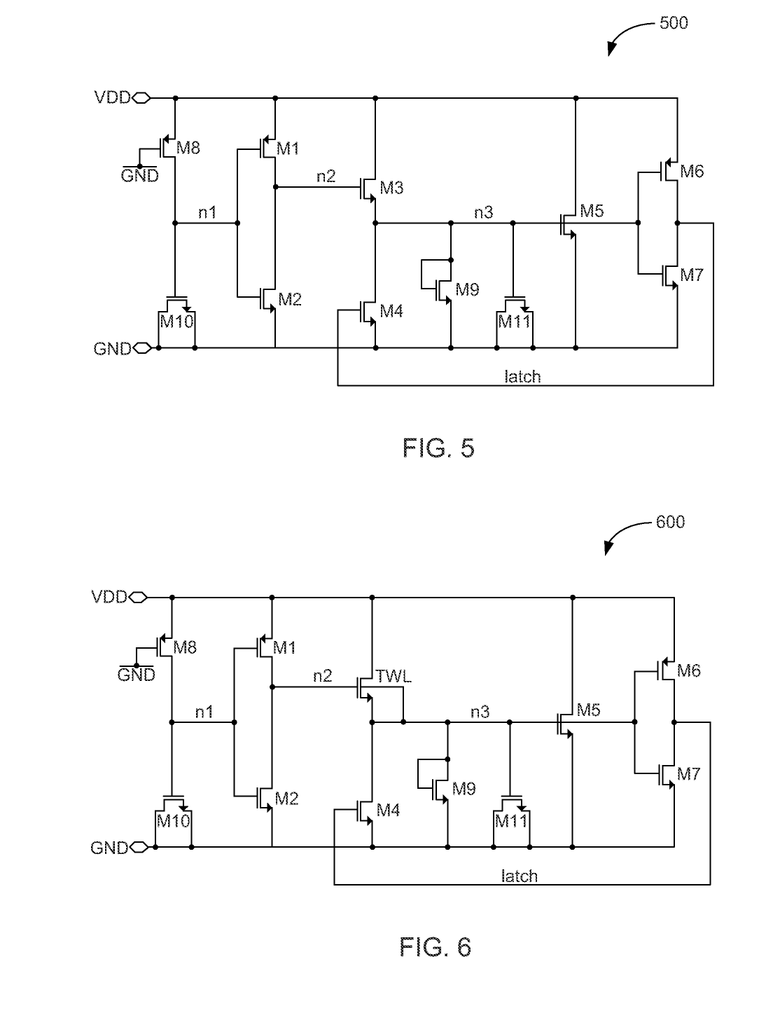

FIG. 5 schematically illustrates an alternative configuration of ESD circuitry 500, according to various embodiments. The ESD circuitry 500 may comport with embodiments described in connection with ESD circuitry 400 of FIG. 4, except that the one or more capacitors of C1 and C2 of FIG. 4 have been replaced by one or more additional transistors (hereinafter “tenth transistor M10” and “eleventh transistor M11,” respectively). According to various embodiments, a capacitance of the first node n1 and/or third node n3 may be based on the tenth transistor M10 and/or eleventh transistor M11.

The tenth transistor M10 may include a source coupled with GND, a drain coupled with GND and a gate coupled with the first node n1, as can be seen. The eleventh transistor M11 may include a source coupled with GND, a drain coupled with GND and a gate coupled with the third node n3, as can be seen. A gate capacitance of the tenth transistor M10 and eleventh transistor M11 may be configured, tuned or selected to provide a first time period (e.g., τ1) of the first node n1 and a second time period (e.g., τ2) of the third node n3 as described in connection with ESD circuitry 200 of FIG. 2. In some embodiments, the ninth transistor M9 may be a zero threshold voltage transistor. Replacing C1 and C2 of the ESD circuitry 400 with the tenth transistor M10 and eleventh transistor M11 may reduce die area in the ESD circuitry 500 relative to the ESD circuitry 400.

In an embodiment corresponding with the first embodiment described in connection with the ESD circuitry 200 of FIG. 2, the eighth transistor M8 may have a width of 2 microns and a channel length of 10 microns, the ninth transistor M9 may have a width of 1 microns and a channel length of 20 microns, the tenth transistor M10 may have a width of 10 microns and a channel length of 10 microns, the eleventh transistor M11 may have a width of 80 microns and a channel length of 10 microns. The transistors M8-M11 may have other suitable dimensions in other embodiments.

FIG. 6 schematically illustrates an alternative configuration of ESD circuitry 600, according to various embodiments. The ESD circuitry 600 may comport with embodiments described in connection with ESD circuitry 500 of FIG. 5, except that the third transistor M3 of FIG. 5 has been replaced by a triple-well transistor, TWL.

The triple-well transistor TWL may include a source coupled with the third node n3, a drain coupled with VDD and a gate coupled with the second node n2, as can be seen. Further, a body of the triple-well transistor TWL may be coupled with the third node n3, as can be seen. In some embodiments, the triple-well transistor TWL may be an isolated transistor, e.g., a body of the transistor is isolated from the bulk silicon. In some embodiments, the triple-well transistor TWL may be isolated from the bulk by means of a silicon-on-insulator (SOI) process. In some embodiments, the triple-well transistor may be an SOI transistor. In some embodiments, the triple-well transistor TWL may be an N-type FET (NFET). In some embodiments, replacing the third transistor M3 of FIG. 5 with the triple-well transistor TWL may reduce a body effect and/or a peak transient voltage in the ESD circuitry 600 (e.g., as the second node n2 is rising and the third transistor M3 is pulling up the third node n3). In an embodiment corresponding with the first embodiment described in connection with the ESD circuitry 200 of FIG. 2, the triple-well transistor TWL may have similar dimensions as the third transistor M3.

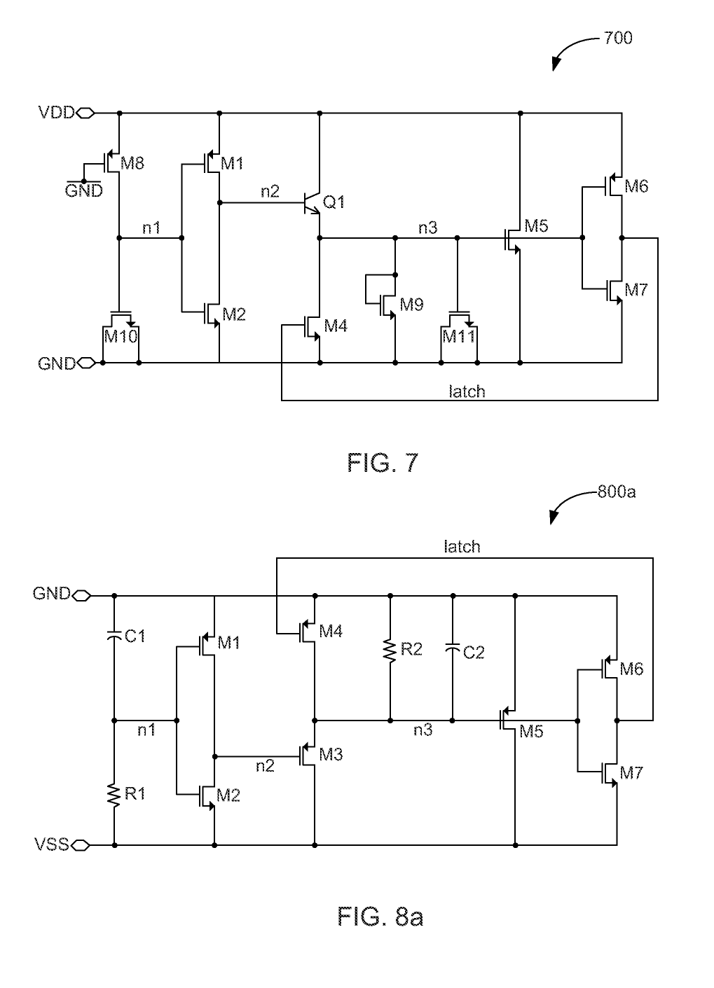

FIG. 7 schematically illustrates an alternative configuration of ESD circuitry 700, according to various embodiments. The ESD circuitry 700 may comport with embodiments described in connection with ESD circuitry 500 of FIG. 5, except that the third transistor M3 of FIG. 5 has been replaced by a bipolar transistor Q1.

The bipolar transistor Q1 may include an emitter coupled with the third node n3, a collector coupled with VDD and a base coupled with the second node n2, as can be seen. In some embodiments, the bipolar transistor Q1 may be formed according to a BiCMOS process. In some embodiments, replacing the third transistor M3 of FIG. 5 with the triple-well transistor TWL may reduce a peak transient voltage in the ESD circuitry 700 (e.g., as the second node n2 is rising and the third transistor M3 is pulling up the third node n3).

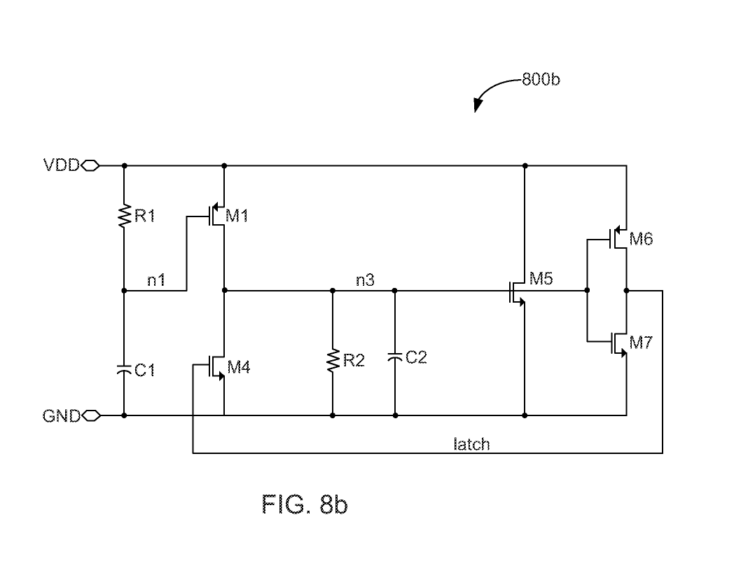

FIG. 8a schematically illustrates an alternative configuration of ESD circuitry 800a, according to various embodiments. The ESD circuitry 800a may represent a reconfiguration of the ESD circuitry 200 of FIG. 2 to protect a negative supply voltage node (VSS), as can be seen. The components of the ESD circuitry 800a may comport with embodiments described in connection with ESD circuitry 200 of FIG. 2. Various components of the ESD circuitry 800a may be replaced with alternative components as described in connection with FIGS. 3-7.

FIG. 8b schematically illustrates an alternative configuration of ESD circuitry 800b, according to various embodiments. The ESD circuitry 800b may represent a simplified configuration of the ESD circuitry 200 of FIG. 2 where transistors M2, M3 and node n2 have been eliminated from the circuitry. In some embodiments, the ESD circuitry 800b may be further simplified. For example, the latch formed by transistors M4, M6 and M7 may be optional in some embodiments and/or may be replaced with other suitable circuitry.

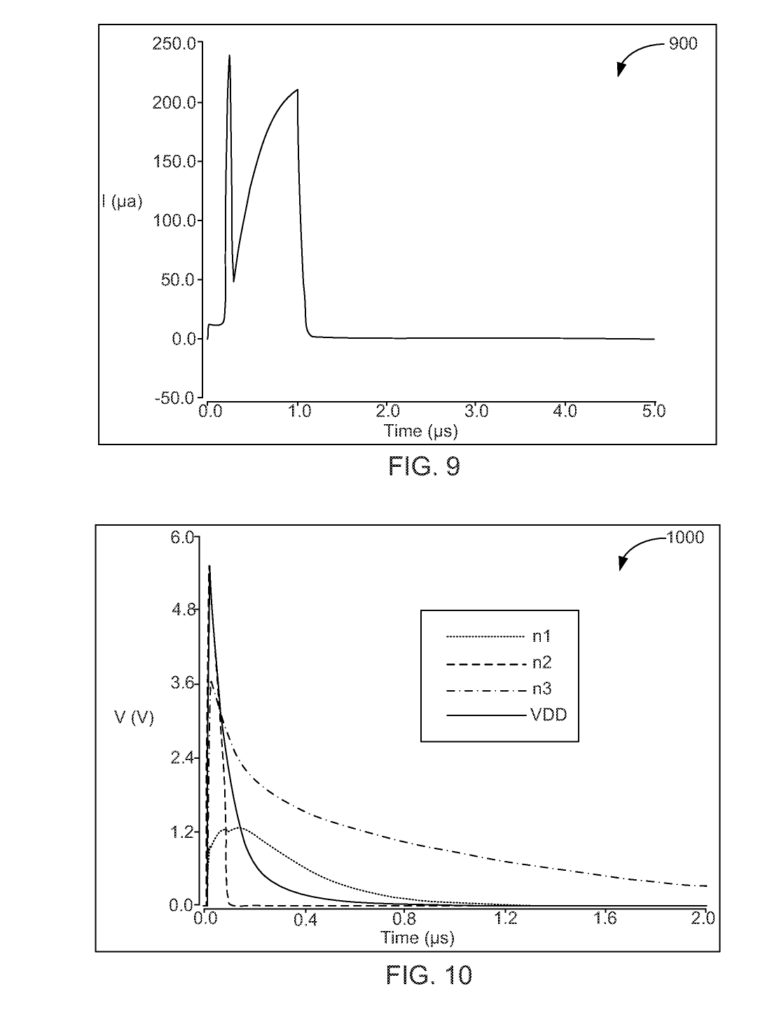

FIG. 9 schematically illustrates an example graph 900 of current (I) of a supply voltage node (e.g., VDD) over time for the ESD circuitry 200 of FIG. 2, according to various embodiments. The current is represented in microamperes (μA) and the time is represented in microseconds (μs). In the graph 900, the current represents in-rush current for a 5V supply having a 1 microsecond rise time with a series resistance Rₛ of 20 ohms.

As can be seen, the current peaks at 250 μA or less. The supply voltage (e.g., VDD of ESD circuitry 200) may reach a peak voltage of about 5.5V and may quickly discharge without oscillating as may occur with ESD circuitry including multiple inverters. A first peak in time may correspond with the first time period (e.g., τ1) and the second peak in time may correspond with the second time period (e.g., τ2). The current drops to ˜0 μA at ˜1 μs when the latch node goes high, pulling node n3 to GND.

FIG. 10 schematically illustrates an example graph 1000 of voltage of various nodes over time for the ESD circuitry 200 of FIG. 2, according to various embodiments. In particular, a voltage of VDD, the first node n1, the second node n2 and the third node n3 is depicted. The voltage is represented in volts (V) and the time is represented in μs. The graph 1000 may represent voltage over time for a configuration in accordance with the second embodiment described in connection with the ESD circuitry 200 of FIG. 2 in response to a human body model ESD event.

Referring to FIGS. 2 and 10, initially, an ESD pulse is applied with a 10 ns rise time, causing VDD to rapidly increase to a peak of about 5.5V. A voltage of the first node n1 may lag behind due to the first time period (e.g., τ1=180 ns) causing a voltage of the second node n2 to track VDD up and then down. A voltage of the third node n3 may be pulled up to about 3.7V by the third transistor M3, turning on the fifth transistor M5. Current may have a peak of about 1.33 amperes (A) (e.g., ID=2000V/1.5 Kohms) as determined by a 2000 V human body model ESD event. VDD begins rapidly decaying from the peak voltage, turning off the third transistor M3. The third node n3 decays from its peak according to the second time period (e.g., τ2=1.23 us) completely discharging the external ESD capacitance before turning off the fifth transistor M5. The voltage of the second node n2 may rapidly switch low when VDD falls below about twice the peak voltage of the first node (e.g., ˜2.4V).

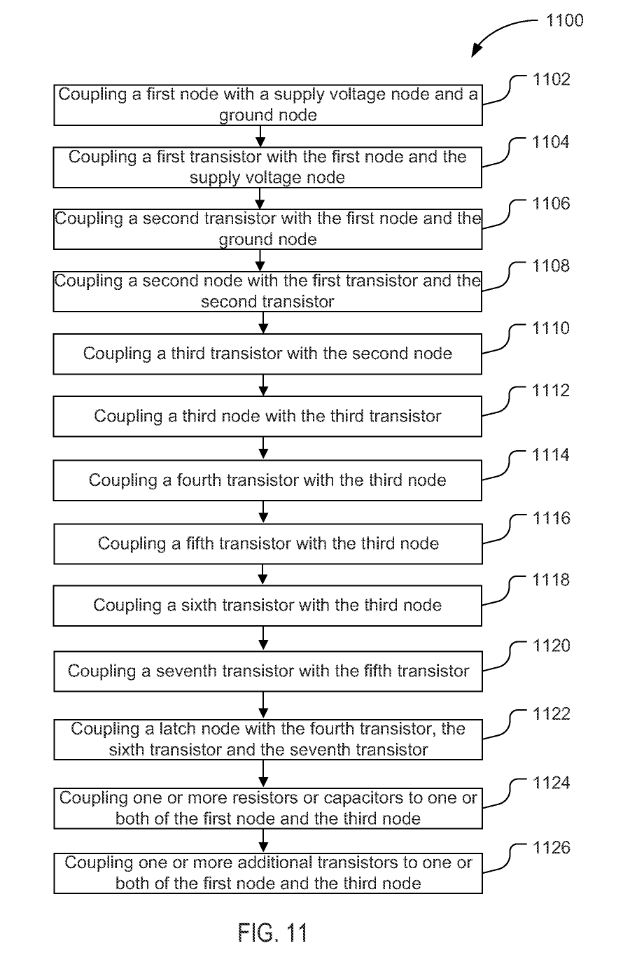

FIG. 11 is a flow diagram of a method 1100 for fabricating or designing ESD circuitry, according to various embodiments. The method 1100 may comport with embodiments described in connection with FIGS. 1-10.

At 1102, the method 1100 may include coupling a first node (e.g., first node n1 of FIGS. 2-8) with a supply voltage node (e.g., VDD of FIGS. 2-7 or VSS of FIG. 8a) and a ground node (e.g., GND of FIGS. 2-8). At 1104, the method 1100 may include coupling a first transistor (e.g., first transistor M1 of FIGS. 2-7 or second transistor M2 of FIG. 8a) with the first node and the supply voltage node. At 1106, the method 1100 may include coupling a second transistor (e.g., second transistor M2 of FIGS. 2-7 or first transistor M1 of FIG. 8a) with the first node and the ground node. At 1008, the method 1100 may include coupling a second node (e.g., the second node n2 of FIGS. 2-8) with the first transistor and the second transistor. At 1110, the method 1100 may include coupling a third transistor (e.g., third transistor M3 of FIGS. 2-5, 8 or triple-well transistor TWL or SOI transistor of FIG. 6 or bipolar transistor Q1 of FIG. 7) with the second node.

At 1112, the method 1100 may include coupling a third node (e.g., third node n3 of FIGS. 2-8) with the third transistor. At 1114, the method 1100 may include coupling a fourth transistor (e.g., fourth transistor M4 of FIGS. 2-8) with the third node. At 1116, the method 1100 may include coupling a fifth transistor (e.g., fifth transistor M5 of FIGS. 2-8) with the third node. At 1118, the method 1100 may include coupling a sixth transistor (e.g., sixth transistor M6 of FIGS. 2-8) with the third node. At 1120, the method 1100 may include coupling a seventh transistor (e.g., seventh transistor M7 of FIGS. 2-8) with the third node.

At 1122, the method 1100 may include coupling a latch node (e.g., latch node of FIGS. 2-8) with the fourth transistor, the sixth transistor and the seventh transistor. At 1124, the method 1100 may include coupling one or more resistors (e.g., R1 and/or R2 of FIGS. 2-3, 8) or capacitors (e.g., C1 and/or C2 of FIGS. 2-4, 8) to one or both of the first node and the third node. At 1126, the method 1100 may include coupling one or more additional transistors (e.g., eighth transistor M8 of FIGS. 3-7, ninth transistor M9 of FIGS. 4-7, tenth transistor M10 of FIGS. 5-7 or eleventh transistor M11 of FIGS. 5-7) to one or both of the first node and the third node.

Various operations are described as multiple discrete operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

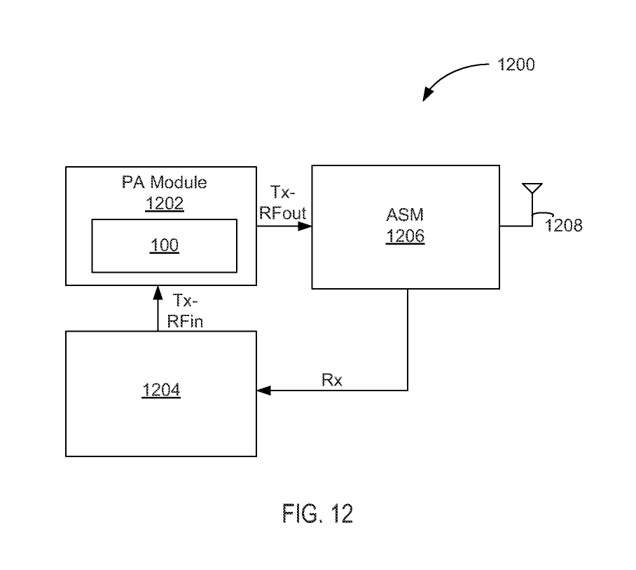

Embodiments of ESD circuitry described herein, and apparatuses (e.g., die 100 of FIG. 1) including such ESD circuitry may be incorporated into various other apparatuses and systems. FIG. 12 schematically illustrates an example system 1200 including a die 100 having ESD circuitry (e.g., ESD circuitry 200, 300, 400, 500, 600, 700 or 800 of respective FIG. 2, 3, 4, 5, 6, 7 or 8), according to various embodiments. As illustrated, the system 1200 includes a power amplifier (PA) module 1202, which may be a Radio Frequency (RF) PA module in some embodiments. The system 1200 may include a transceiver 1204 coupled with the power amplifier module 1202 as illustrated. The power amplifier module 1202 may include a die 100 having ESD circuitry as described herein.

The power amplifier module 1202 may receive an RF input signal, RFin, from the transceiver 1204. The power amplifier module 1202 may amplify the RF input signal, RFin, to provide the RF output signal, RFout. The RF input signal, RFin, and the RF output signal, RFout, may both be part of a transmit chain, respectively noted by Tx−RFin and Tx−RFout in FIG. 12.

The amplified RF output signal, RFout, may be provided to an antenna switch module (ASM) 1206, which effectuates an over-the-air (OTA) transmission of the RF output signal, RFout, via an antenna structure 1208. The ASM 1206 may also receive RF signals via the antenna structure 1208 and couple the received RF signals, Rx, to the transceiver 1204 along a receive chain.

In various embodiments, the antenna structure 1208 may include one or more directional and/or omnidirectional antennas, including, e.g., a dipole antenna, a monopole antenna, a patch antenna, a loop antenna, a microstrip antenna or any other type of antenna suitable for OTA transmission/reception of RF signals.

The system 1200 may be any system including power amplification. Circuitry of the die 100 may provide an effective switch device for power-switch applications including power conditioning applications such as, for example, Alternating Current (AC)-Direct Current (DC) converters, DC-DC converters, DC-AC converters, and the like. In various embodiments, the system 1200 may be particularly useful for power amplification at high radio frequency power and frequency. For example, the system 1200 may be suitable for any one or more of terrestrial and satellite communications, radar systems, and possibly in various industrial and medical applications. More specifically, in various embodiments, the system 1200 may be a selected one of a radar device, a satellite communication device, a mobile handset, a cellular telephone base station, a broadcast radio, or a television amplifier system.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims and the equivalents thereof.

What is claimed is:

1. Electrostatic discharge (ESD) circuitry comprising:
a first node coupled with a supply voltage node and a ground node;
a first transistor coupled with the first node and the supply voltage node;
a second transistor coupled with the first node and the ground node;
a second node coupled with the first transistor and the second transistor;
a third transistor coupled with the second node; and
a third node coupled with the third transistor, wherein a first time period to charge the first node is less than a second time period to discharge the third node.

2. The ESD circuitry of claim 1, further comprising:
a fourth transistor coupled with the third node, wherein the second time period to discharge the third node begins when the third transistor is set to an off-state and ends when the fourth transistor is set to an on-state.

3. The ESD circuitry of claim 2, wherein:
the first node is coupled with a gate of the first transistor and a gate of the second transistor;
the second node is coupled with a drain of the first transistor and a drain of the second transistor;
a source of the first transistor is coupled with the supply voltage node; and
a source of the second transistor is coupled with the ground node.

4. The ESD circuitry of claim 3, wherein:
the second node is coupled with a gate or base of the third transistor;
the third node is coupled with a source or emitter of the third transistor and a drain of the fourth transistor;
a drain or collector of the third transistor is coupled with the supply voltage node; and
a source of the fourth transistor is coupled with the ground voltage.

5. The ESD circuitry of claim 2, further comprising:
a fifth transistor coupled with the third node, wherein the third node is coupled with a gate of the fifth transistor;
a sixth transistor coupled with the fifth transistor, wherein a gate of the fifth transistor is coupled with a gate of the sixth transistor;
a seventh transistor coupled with the fifth transistor, wherein the gate of the fifth transistor is coupled with a gate of the seventh transistor; and
a latch node coupled with the sixth transistor, the seventh transistor and the fourth transistor, wherein the latch node is coupled with a drain of the sixth transistor, a drain of the seventh transistor and a gate of the fourth transistor.

6. The ESD circuitry of claim 1, wherein the second time period is at least seven times greater than the first time period.

7. The ESD circuitry of claim 1, wherein:
the first time period has a value less than 1 microsecond (μs); and
the second time period is greater than the first time period.

8. The ESD circuitry of claim 1, further comprising:
one or more resistors or capacitors coupled to one or both of the first node and the third node, wherein a resistance or capacitance of at least the first node or the third node is based on the one or more resistors or capacitors.

9. The ESD circuitry of claim 1, further comprising:
one or more additional transistors coupled with one or both of the first node and the third node, wherein a resistance or capacitance of at least the first node or the third node is based on the one or more additional transistors.

10. The ESD circuitry of claim 1, wherein the third transistor is a triple-well transistor or a silicon-on-insulator (SOI) transistor.

11. A method of fabricating electrostatic discharge (ESD) circuitry comprising:
coupling a first node with a supply voltage node and a ground node;
coupling a first transistor with the first node and the supply voltage node;
coupling a second transistor with the first node and the ground node;
coupling a second node with the first transistor and the second transistor;
coupling a third transistor with the second node; and
coupling a third node with the third transistor, wherein a first time period to charge the first node is less than a second time period to discharge the third node.

12. The method of claim 11, further comprising:
coupling a fourth transistor with the third transistor, wherein the second time period to discharge the third node begins when the third transistor is set to an off-state and ends when the fourth transistor is set to an on-state.

13. The method of claim 12, wherein:
the first node is coupled with a gate of the first transistor and a gate of the second transistor;
the second node is coupled with a drain of the first transistor and a drain of the second transistor;
a source of the first transistor is coupled with the supply voltage node; and
a source of the second transistor is coupled with the ground node.

14. The method of claim 13, wherein:
the second node is coupled with a gate or base of the third transistor;
the third node is coupled with a source or emitter of the third transistor and a drain of the fourth transistor;
a drain or collector of the third transistor is coupled with the supply voltage node; and
a source of the fourth transistor is coupled with the ground voltage.

15. The method of claim 12, further comprising:
coupling a fifth transistor with the third node, wherein the third node is coupled with a gate of the fifth transistor;
coupling a sixth transistor with the fifth transistor, wherein a gate of the fifth transistor is coupled with a gate of the sixth transistor;
coupling a seventh transistor with the fifth transistor, wherein the gate of the fifth transistor is coupled with a gate of the seventh transistor; and
coupling a latch node with the sixth transistor, the seventh transistor and the fourth transistor, wherein the latch node is coupled with a drain of the sixth transistor, a drain of the seventh transistor and a gate of the fourth transistor.

16. The method of claim 11, wherein the second time period is at least seven times greater than the first time period.

17. The method of claim 11, wherein:
the first time period is less than 1 microsecond (μs); and
the second time period is greater than the first time period.

18. The method of claim 11, further comprising:
coupling one or more resistors or capacitors to one or both of the first node and the third node, wherein a resistance or capacitance of at least the first node or the third node is based on the one or more resistors or capacitors.

19. The method of claim 11, further comprising:
coupling one or more additional transistors with one or both of the first node and the third node, wherein a resistance or capacitance of at least the first node or the third node is based on the one or more additional transistors.

20. A system comprising:
a power amplifier module including a die, the die including:
a power connection configured to provide a supply voltage node for operation of the die;
a ground connection configured to provide a ground node; and
an electrostatic discharge (ESD) clamp coupled with the supply voltage node and the ground node, the ESD clamp comprising:
a first node coupled with the supply voltage node and the ground node;
a first transistor coupled with the first node and the supply voltage node;
a second transistor coupled with the first node and the ground node;
a second node coupled with the first transistor and the second transistor;
a third transistor coupled with the second node; and
a third node coupled with the third transistor, wherein a first time period to charge the first node is less than a second time period to discharge the third node.

21. The system of claim 20, wherein the ESD clamp further comprises:
a fourth transistor coupled with the third transistor, wherein the second time period to discharge the third node begins when the third transistor is set to an off-state and ends when the fourth transistor is set to an on-state.
